(19) United States
(12) Patent Application Publication
(10) Pub. No.: US 2008/0153930 A1
(43) Pub. Date: Jun. 26, 2008

(54) Functionalized Sol-Gel Material, Sol-Gel Film Derived Therefrom, and Method for Preparing the Same

(75) Inventors: Guang-Way Jang, Hsin-Chu (TW); Ya-Hui Lin, Hsinchu City (TW); Mei-Chih Hung, Changhua City (TW); Pei Tien, Jhubei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INDUSTRIAL TECHNOLOGY RESEARCH INSTITUTE, Chutung Town (TW)

(21) Appl. No.: 11/951,777

(22) Filed: Dec. 6, 2007

Related U.S. Application Data
(63) Continuation-in-part of application No. 10/889,306, filed on Jul. 12, 2004.

(51) Int. Cl. B01F 3/12

(52) U.S. Cl. 516/100

(57) ABSTRACT

A method of preparing a sol-gel material is described. A M(OR)x and an organically modified Si-alkoxide having a predetermined functional group are dissolved in a first solvent and a second solvent to form a first solution and a second solution, respectively. The first solution and the second solution are then mixed and heated. As a result, the M(OR)x reacts with the organically modified Si-alkoxide to form a functionalized sol-gel material. Furthermore, the solid content of the functionalized sol-gel material is increased by transferring the same into another solvent. Therefore, a thick sol-gel film is fabricated by means of the transferred functionalized sol-gel material.

### CROSS-REFERENCE TO RELATED APPLICATIONS

This application is a continuation-in-part of U.S. application Ser. No. 10/889,306, filed on Jul. 12, 2004, hereby incorporated by reference as it fully set forth herein.

### FIELD OF THE INVENTION

The present invention relates to a sol-gel material, and more particularly, to a functionalized sol-gel material, a method of preparing the same, and a sol-gel film derived therefrom.

### BACKGROUND

Organic-inorganic hybrid materials possess not only the advantages of organic materials, such as processability and flexibility, but also the advantages of inorganic materials, like high mechanical strength and high thermal properties, and hence are studied internationally and are widely applied in various fields. In general, a hybrid material is prepared by mixing an organic material and an inorganic material, which are associated by molecular forces therebetween, such as, for example, London-van der Waals force or hydrogen bonding, on a nanometer scale. Therefore, the hybrid material is formed without phase separation in the macroscopic view, and further combines the properties of the organic material and the inorganic material.

Due to the poor thermal properties of organic materials, organic-inorganic hybrid materials cannot be prepared in a conventional ceramic-manufacturing process. Instead, a sol-gel process is usually adopted to fabricate organic-inorganic hybrid materials. Sol-gel process including a hydrolysis step and a condensation step performed at a low temperature. Consequently, organic materials can be introduced into inorganic materials without degradation.

The organic-inorganic hybrid materials prepared by the sol-gel process, however, are easily influenced by surrounding conditions, such as, for instance, temperature or humidity. As a result, the organic-inorganic sol-gel materials tend to age, which decreases the shelf life thereof. Additionally, the organic-inorganic sol-gel materials with a nanometer dimension incline to aggregate with one another. To stabilize the properties and the sizes of the organic-inorganic sol-gel materials, chelating agents are required in preparing the same. The chelating agents are, for example, methacrylic acid, acetic acid, and acetyl acetone.

On the other hand, the solid content of the organic-inorganic sol-gel materials prepared by the sol-gel process is usually around 20% to 30%, of which the viscosity is not high enough for preparing a thick sol-gel film. Unfortunately, raising the solid content by increasing reaction time and reactant concentrations directly results in gelation of the organic-inorganic sol-gel materials. Moreover, phase separation occurs if the viscosity of the organic-inorganic sol-gel materials is increased by adding another polymer solution with higher viscosity.

### SUMMARY

According to an embodiment of this invention, a functionalized organic-inorganic sol-gel material and a preparation method thereof are provided. An organic material and an inorganic material are separately mixed with corresponding solvents, followed by mixing the solvents and heating the same for a period of time to form a functionalized organic-inorganic sol-gel material. The inorganic material is a metal alkoxide or silicon alkoxide wherein the valence of the metal atom or silicon atom therein is greater than zero, while the organic material is an organically modified Si-alkoxide. The interaction between the sol-gel materials is effectively reduced, which prevents the sol-gel materials from aggregating with one another, by selecting proper solvents at the beginning of preparation. Therefore, the functionalized organic-inorganic sol-gel material with a stable nanometer dimension is formed by means of the selected solvents instead of any chelating agents.

According to another embodiment of this invention, a method for preparing a thick sol-gel film derived from a functionalized sol-gel material is provided. The solid content of a functionalized sol-gel material is dramatically raised by transferring the sol-gel material into a selected solvent. A thick and uniform film is then formed more easily, since the solid content of the sol-gel material has been increased. Hence, the sol-gel material after being transferred can be used to fabricate directly a thick film with no need of other adhesives, like polymer solution with higher viscosity.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 illustrates a flowchart of preparing a functionalized sol-gel material in accordance with an embodiment of the present invention;

FIG. 2 illustrates an infrared spectrum of the functionalized sol-gel material prepared according to FIG. 1;

FIG. 3 shows a TEM picture of the functionalized sol-gel material prepared according to FIG. 1;

FIG. 4 illustrates a flowchart of preparing a thick sol-gel film in accordance with another embodiment of the present invention;

FIGS. 5A-5F show TEM pictures of the functionalized sol-gel materials prepared in accordance with another embodiment of the present invention;

FIG. 6. illustrates an infrared spectrum of tertabutyl orthotitanate; and

FIG. 7 illustrates a transmission testing result of thick sol-gel films in accordance with another embodiment of the present invention.

### DETAILED DESCRIPTION OF THE EMBODIMENTS

It is found that an organic-inorganic sol-gel material with a stable dimension on a nanometer scale is prepared with no need of chelating agents, if the stability of a reactive solution is properly controlled according to the following equations at the beginning of preparation.

$$\begin{matrix}{V}_{att} = - \frac{{A}_{13}}{12} H ( x , y ) & ( 1 ) \\ {A}_{13} = \frac{3}{4} {kT [ \frac{ɛ 1 - ɛ 3}{ɛ 1 + ɛ 3} ]}^{2} + \frac{3 {hv}_{e}}{16 \sqrt{2}} \cdot \frac{{( {n}_{1}^{2} - {n}_{3}^{2} )}^{2}}{{( {n}_{1}^{2} + {n}_{3}^{2} )}^{3 / 2}} & ( 2 )\end{matrix}$$

Equation (1) represents the attraction energy (Vₐₜₜ) between two spherical particles (medium 1) dispersed in a medium 3, where A₁₃ is the Hamaker constant and H(x, y) is the Hamaker function, which depends on the inter-particle distance and on the particle radius. An approximate expression for A₁₃ is given by equation (2), where ∈1 and ∈3 are the dielectric constants of the media, n₁ and n₃ are their refractive indexes in the visible range, νₑ is the absorption frequency of the media assumed to be the same for both of them, k is the Boltzmann constant (1.38×10⁻²³ J·K⁻¹), T is the absolute temperature, and h is the Planck's constant (6.626×10⁻³⁴ J·s).

According to these equations, the interaction between particles is dependent on the properties of a medium where the particles are dispersed. Consequently, the attraction energy between particles is reduced if an adequate medium is selected; the particles are thus less attracted to one another and aggregate less. Therefore, particles with stable dimensions are obtained without using any chelating agents. By this principle, a functionalized sol-gel material, a method for preparing the same, and a thick sol-gel film derived therefrom in accordance with the embodiments of the present invention are disclosed in detail as follows, taken in conjunction with the accompanying drawings.

### Embodiment 1

One aspect of the present invention is to provide a metal alkoxide/silicon alkoxide and an organically modified Si-alkoxide having a predetermined functional group as precursors to form a functionalized sol-gel material. Additionally, solvents are selected according to the principle mentioned above before preparing the material. As a result, stable reactive surroundings for the material are provided at the beginning of preparation.

The metal alkoxide or silicon alkoxide can be formulated as M(OR)ₓ, where M is a metal atom or silicon atom, x is the valence of M, and R represents C₁-C₁₂ alkyl. Further, the valence of the metal atom (i.e. the difference between the coordination number and the valence of M) is greater than zero. The metal atom is, for example, titanium (Ti), zirconium (Zr), germanium (Ge), tin (Sn), zinc (Zn), or aluminum (Al). The aforesaid alkoxide includes zirconium butoxide (Zr(OBu)₄), zirconium proxide (Zr(OPr)₄), germanium (IV) ethoxide (Ge(OC₂H₅)₄), germanium (IV) isopropoxide (Ge[OCH(CH₃)₂]₄), titanium ethoxide (Ti(OC₂H₅)₄), tertabutyl orthotitanate (Ti(OC₄H₉)₄), tin (IV) tert-butoxide (Sn(OC₄H₉)₄), tetraethyl orthosilicate (Si(OC₂H₅)₄), zinc acetate dihydrate (Zn(CH₃COO)₂), or aluminum sec-butoxide (Al[OC(CH₃)₂]₃), and is preferably zirconium butoxide in the embodiment. Furthermore, the organically modified Si-alkoxide can be expressed as R¹Si(OR)₃ or R¹R²Si(OR)₂, where R represents C₁-C₁₂ alkyl, and R¹ and R² are hydrocarbyl groups that may be different or the same. The predetermined functional group (R¹ or R²) may be an epoxy group or an amine group (—NH), or an unsaturated functional group, such as a vinyl group, an acryl group, or a photosensitive derivative thereof. Moreover, methacryloxypropyl tri-methoxysilane (MPTMS) is preferably used in the embodiment.

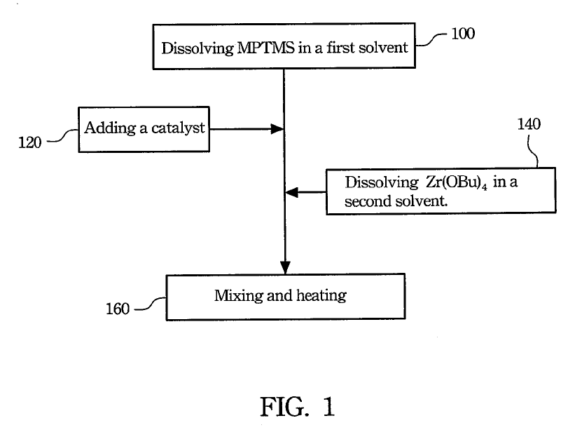

Reference is made to FIG. 1, which illustrates a flowchart of the process of preparing a functionalized sol-gel material in accordance with the embodiment. According to step 100, MPTMS of about 15 g (about 0.06 mole) is dissolved in a first solvent of about 30 g to form a first solution, which is then stirred about 30 to 60 minutes. A catalyst is further added to the first solution for aiding the hydrolysis of the MPTMS, in step 120. In the embodiment, the catalyst is 0.1N hydrochloride solution (HCl). In step 140, a second solution is formed by dissolving zirconium butoxide in a second solvent and stirring the second solution for around 10 to 30 minutes. The first solution and the second solution are next mixed and heated for a period of time in step 160. Generally, the temperature to which the solutions are heated is slightly lower than the boiling points of the solvents. Moreover, the first solvent may be the same as the second solvent, and hence the reaction is controlled more easily. In the embodiment of the present invention, the first solvent and the second solvent are both tetra-hydrofuran (THF), and the heating temperature is around 65° C.

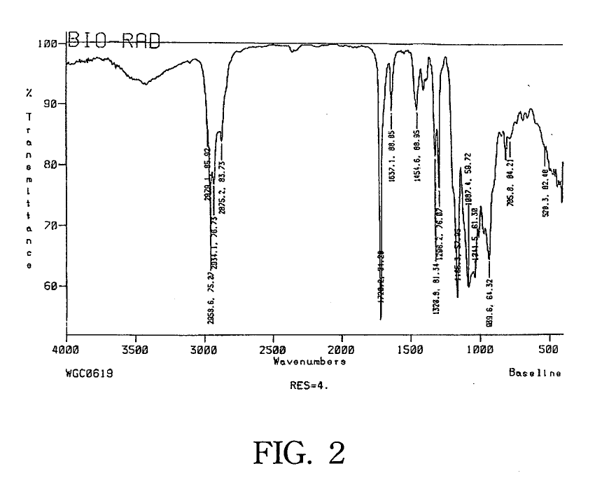

The resultant material is a transparent solution, which also implies that the resultant particles are on a nanometer (nm) scale and are well dispersed in the solvents. The Fourier Transformation infrared (FTIR) spectrum of the particles is shown in FIG. 2. The absorption band at around 1600 cm⁻¹ and around 1730 cm⁻¹ are due to the C═C stretching mode and the C═O stretching mode of MPTMS, respectively. The absorption band at about 840 cm⁻¹ is assigned to Zr—O—Si bonding. On this ground, a sol-gel material/particle having a photosensitive group is prepared.

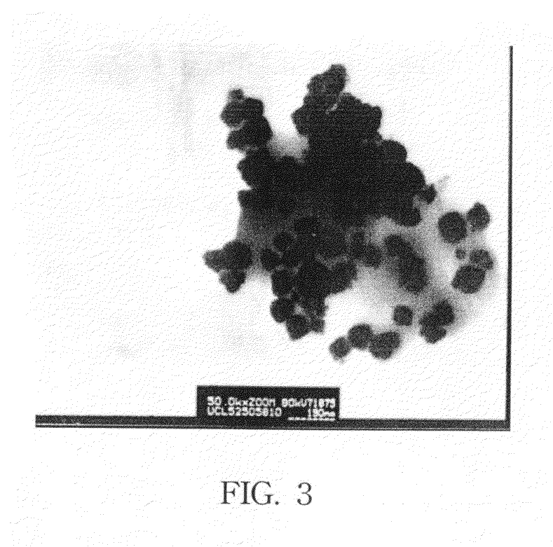

FIG. 3 is the transmission electron microscopy (TEM) picture of the particles, which further proves that the size of the resultant particles is smaller than 100 nm, and that the particle size distribution is uniform.

Further, the attraction energy (A₁₃) of THF as calculated by the aforementioned equation (2) is 11.1 or so. As a result, the interaction between the particles is decreased by THF, which prevents the particles from attracting one another and aggregating. Therefore, a sol-gel particle with stable dimensions is prepared through adequate solvents. Moreover, THF is only an exemplary solvent, and is not intended to limit the invention. Other solvents that provide stable reactive surroundings, for instance, toluene (A₁₃ is about 12.1) or propylene glycol monoether acetate (PMAc) (A₁₃ is about 9.6), are also used to prepare an organic-inorganic sol-gel material with stable dimensions.

On the other hand, the aforenamed precursors and the proportions thereof are merely in favor of illustrating the embodiment. It is appreciated that any substitutes, although not described or shown herein, which embody the principles of the invention, are included within the spirit and scope of the invention. For instance, a sol-gel material having an epoxy group on a nanometer scale is formed through 3-glycidoxypropyl trimethoxysilane (GLYMO), in the case where solvents are appropriately selected at the beginning of preparation.

### Embodiment 2

### Comparative Example

In this embodiment, an organic-inorganic sol-gel material is formed in alcohol under the same preliminary conditions as those in embodiment 1. The material in alcohol is further compared with materials formed in different solvents, which results are listed in Table 1.

TABLE 1
Comparative results of various materials formed in different solvents

| | | | Particle | |
|---|---|---|---|---|
| | Dielectric constant | Attraction energy | size | Solution |
| Solvent | of solvent | (A₁₃) | (nm) | condition |
| THF | 7.6 | 11.1 | <100 | Transparent |
| Toluene | 2.2 | 12.1 | <100 | Transparent |
| PMAc | 6.7 | 9.6 | <100 | Transparent |
| Alcohol | 25.7 | 1.1 | >5000 | Opaque |

It is found from Table 1 that, a transparent solution and nanoparticles are obtained if an adequate solvent is selected. Consequently, particles attract one another and aggregate less, and thus have stable sizes, because solvents decrease the interaction between particles. On the contrary, larger particles are given in alcohol, and the resultant solution is opaque. Furthermore, the dielectric constant of solvents is preferably smaller than 10.

### Embodiment 3

The sol-gel material can be further used for preparing a thick sol-gel film or a thin sol-gel film. In the following embodiment, preparation of a thick sol-gel film is provided.

For preparing a thick sol-gel film, the solid content of a sol-gel material is increased by transferring the same into another solvent in accordance with the present invention. The sol-gel material of Embodiment 1 herein is only an example to describe the process for convenience, which is not proposed to limit the invention.

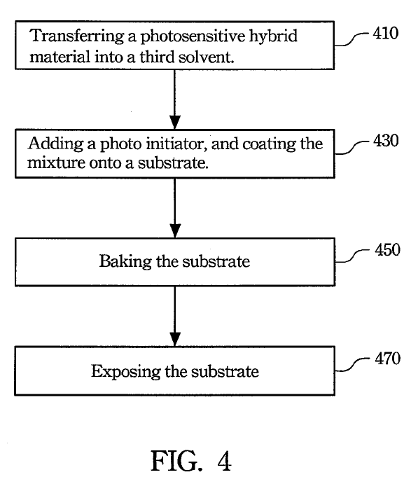

Reference is made to FIG. 4, which illustrates a flowchart of preparing a thick sol-gel film according to the embodiment. The photosensitive sol-gel material of Embodiment 1 is first transferred into a third solvent, in step 410. The boiling point of the third solvent is greater than those of the first solvent and the second solvent. Additionally, the amount of the third solvent is less than the total amount of the first solvent and the second solvent. As a result, the first solvent and the second solvent are removed by heating, and the sol-gel material remains in the third solvent. Therefore, the solid content of the sol-gel material is increased. The third solvent is determined by its compatibility with an applied substrate, and is preferably propylene glycol monoether acetate in this embodiment. Then, in step 430, a photo initiator is mixed in the transferred third solvent, and the mixture is coated onto a substrate thereafter. The substrate is next baked in step 450. This baking step is only for preparing thick sol-gel film, but for the preparation of a thin sol-gel film, the baking step can be skipped. Furthermore, the baking temperature is dependent on the third solvent used. Since propylene glycol monoether was used as the third solvent herein, the baking temperature is around 150° C. Finally, the substrate is exposed in step 470. At this step, the photosensitive sol-gel material on the substrate is further cross-linked thoroughly, and a thick sol-gel film is thus derived. The thickness of the sol-gel film is up to 10 μm and above, when the solid content of the sol-gel material is raised to about 50%. In addition to that, the sol-gel film prepared above can be optionally patterned during the exposure step, and then the area not exposed is removed to leave the pattern on the substrate.

In view of the above, a thick and uniform sol-gel film is derived directly from a transferred sol-gel material in accordance with the embodiment. Consequently, no binder is required, and no phase separation occurs. Additionally, the thickness of a sol-gel film can be controlled by adjusting the solid content of a sol-gel material. Further, the transmission of the sol-gel film coated on a glass is above 90% in the visible range of 400 nm to 700 nm and at wavelengths of 1310 nm and 1550 nm. The baking temperature or species of the initiator and the third solvent are exemplary descriptions only, and are not proposed to limit the invention.

### Embodiment 4

In the following embodiments of the present invention, other metal alkoxides or silicon alkoxide, instead of zirconium butoxide, were also provided to prepare the functionalized sol-gel material. The metal alkoxides or silicon alkoxide used were germanium (IV) ethoxide (Ge(OC₂H₅)₄), germanium (IV) isopropoxide (Ge[OCH(CH₃)₂]₄), titanium ethoxide (Ti(OC₂H₅)₄), tertabutyl orthotitanate (Ti(OC₄H₉)₄), tin (IV) tert-butoxide (Sn(OC₄H₉)₄), zirconium (IV) propoxide (Zr(OC₃H₄)₄), tetraethyl orthosilicate (Si(OC₂H₅)₄), zinc acetate dihydrate (Zn(CH₃COO)₂), or aluminum sec-butoxide (Al[OC(CH₃)₂]₃).

In general, all the procedures of preparing a sol-gel material were the same as described in embodiment 1. Again, MPTMS was used as the organically modified Si-alkoxide, and THF was used as the first and the second solvent. All of the reactants were listed in the following Table 2.

TABLE 2
the reactants used for preparing the functionalized sol-gel material

| | | Sample | | | | | | |
|---|---|---|---|---|---|---|---|---|
| Reactants | | 1 | 2 | 3 | 4 | 5 | 6 | 7 |
| First | MPTMS (g) | 9.578 | 7.98 | 13.4 | 13.4 | 6.12 | 16.76 | 22.35 |
| Solution | THF (g) | 5 | 3.6 | 6 | 6 | 3.02 | 7.5 | 10 |
| | 0.1 N HCl (g) | 0.669 | 0.557 | 0.936 | 0.936 | 0.433 | 1.17 | 1.56 |
| Second | Metal alkoxides/ | germanium (IV) | germanium (IV) | titanium | tertabutyl | tin (IV) | zirconium (IV) | tetraethyl |
| Solution | silicon alkoxide | ethoxide | isopropoxide | ethoxide | orthotitanate | tert-butoxide | propoxide | orthosilicate |
| | (g) | Ge(OC₂H₅)₄ | Ge[OCH(CH₃)₂]₄ | (Ti(OC₂H₅)₄ | (Ti(OC₄H₉)₄ | (Sn(OC₄H₉)₄ | Zr(OC₃H₄)₄ | Si(OC₂H₅)₄ |
| | | 4.88 | 9.42 | 6.11 | 9.12 | 5 | 11 | 9.3 |
| | THF (g) | 3.03 | 2.1 | 3.5 | 3.5 | 29.11 | 4.5 | 5.8 |

| | | | | | | | |
|---|---|---|---|---|---|---|---|
| Solid Content in THF (%) | 48.1 | 45 | 43.3 | 31.1 | 18.8 | 41.3 | 46.9 |
| Solid Content | 68.2 | 67 | 61.3 | 57.1 | 39.2* | 67.4 | 72.9 |
| in PMAc (%) | | | | | | | |

Sample

| Reactants | | 8 | 9 |
|---|---|---|---|
| First Solution | MPTMS (g) | 33.53 | 17.2 |
| | THF (g) | 15 | 65.8 |
| | 0.1 N HCl (g) | 2.34 | 0.228 |
| Second Solution | Metal alkoxides/silicon alkoxide | Zinc acetate | Aluminum |
| | (g) | dihydrate | sec-butoxide |
| | | Zn(CH₃COO)₂ | Al[OC(CH)₃]₃ |
| | | 14.694 | 8.73 |
| | THF (g) | 18.75 | 0 |

| | | |
|---|---|---|
| Solid Content in THF (%) | 43 | 15 |
| Solid Contentin PMAc (%) | 63 | 42 |

*In order to dissolve tin(IV)tert-butoxide in sample 5 completely, few more drops of 0.1NHCl must be added into the second solution of sample 5.
*Zinc acetate dihydrate was treat with 36% HCl first.

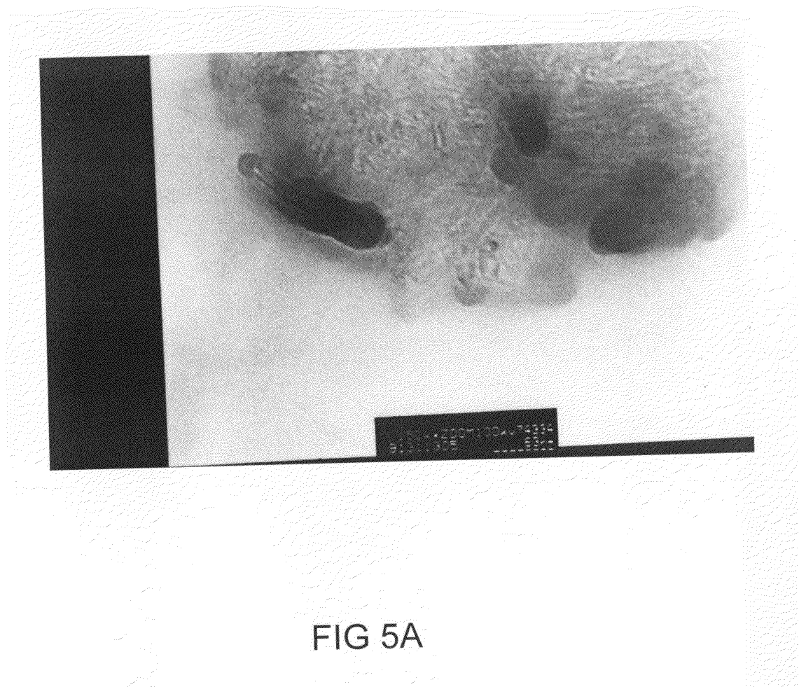

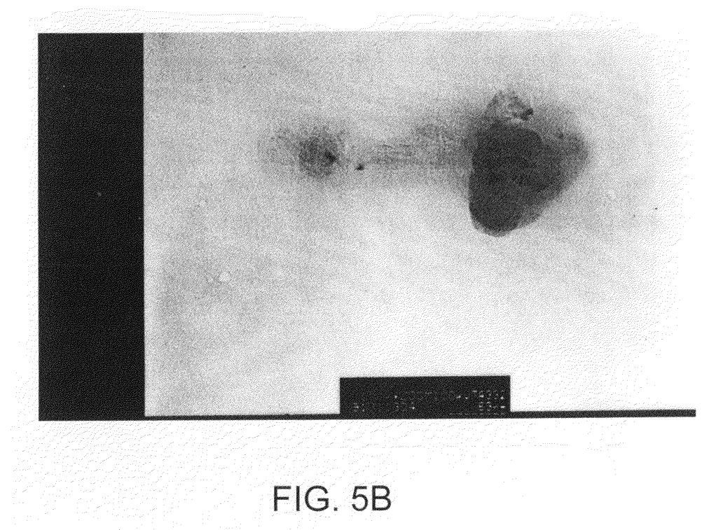

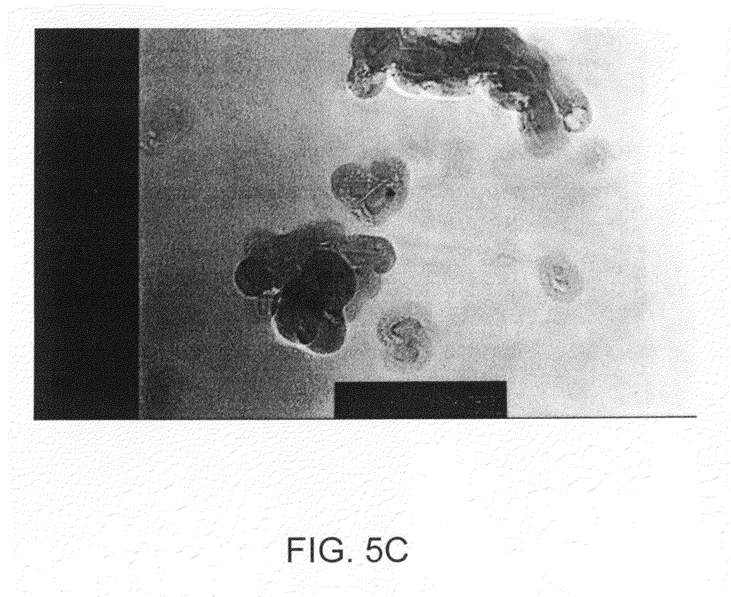

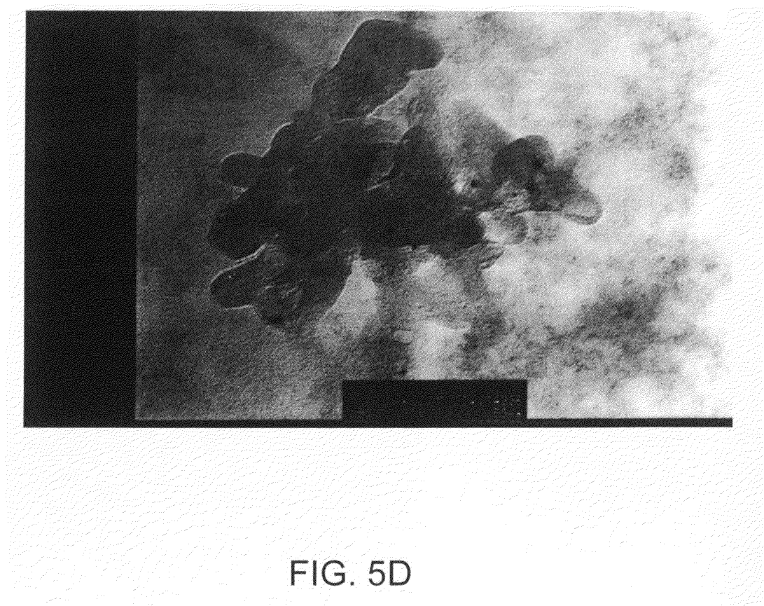

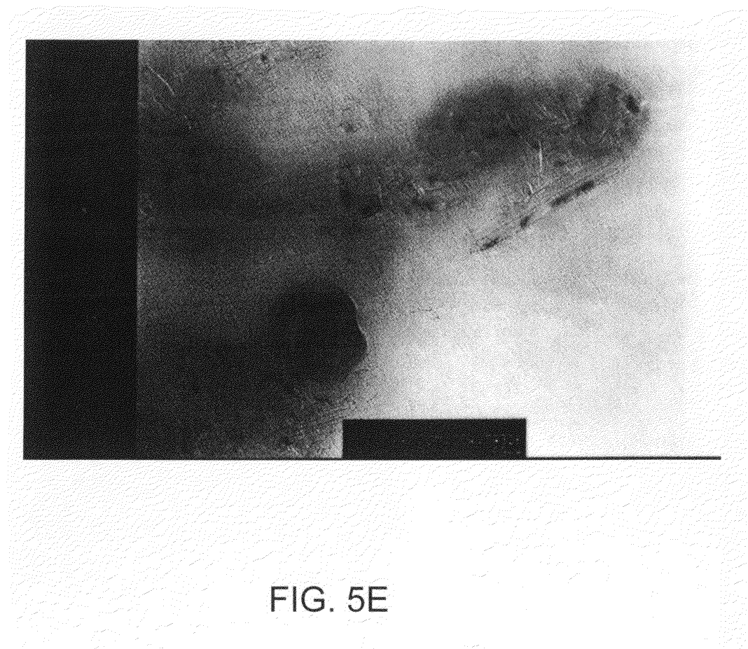

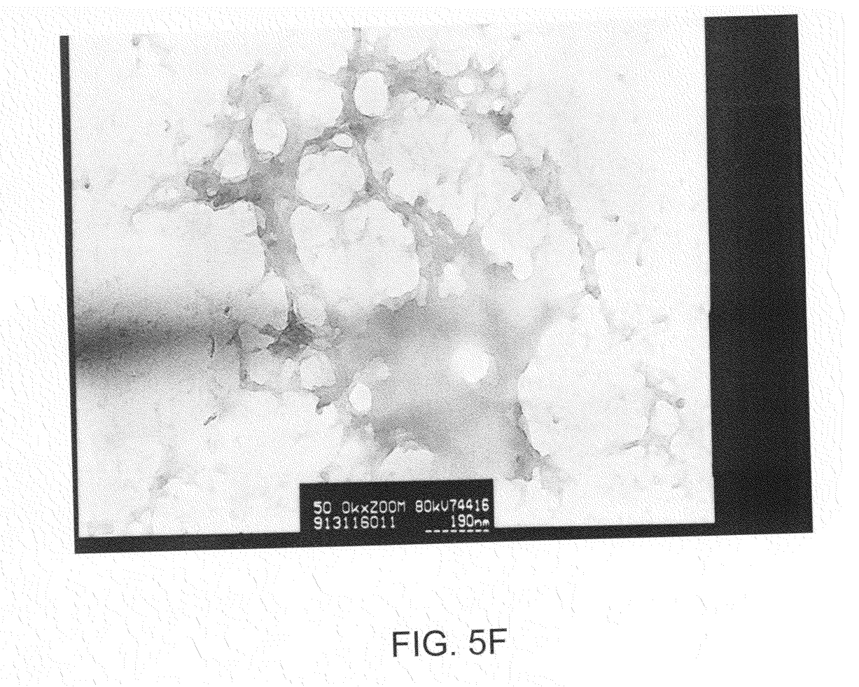

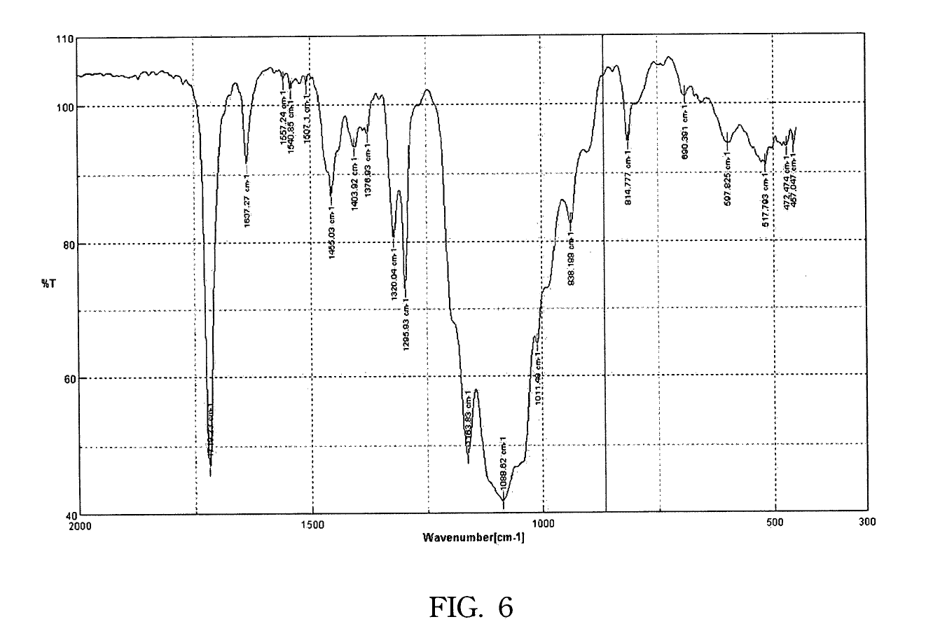

The particle scale of resultant materials prepared above is also detected. The transmission electron microscopy (TEM) pictures of the particles in sample 2, 5, 6, 7, 9, and 3 are shown in FIGS. 5A-5F respectively. As indicated in FIGS. 5A-5F, the size of the resultant particles is below 200 nm, and even is as small as 63 nm. Furthermore, the structures of the resultant materials were also confirmed by the measurement of FTIR. The absorption band of Zn—O—Si is about 720 cm−1, Al—O—Si is around 750 cm⁻¹, and Ti—O—Si is about 950 cm⁻¹. In FIG. 6 provided herein, it shows the FTIR spectrum of tertabutyl orthotitanate (sample 4) wherein the peak at 938 cm⁻¹ is attributed to the Ti—O—Si bonding.

Next, the photosensitive sol-gel material prepared above was transferred into a third solvent, propylene glycol monoether acetate (PMAc). Each sample's solid content was detected before and after transferring into PMAc. The results were also shown in Table 2. By comparing solid content of each sample in Table 2, it was noticed that the solid content of the sol-gel material was increased by transferring the sol-gel material form THF to PMAc. Taking sample 1 for example, the solid content was 48.1% in THF. After transferring sample 1 from THF to PMAc, the solid content was increased to 68.2%. Accordingly, the solid content of the sol-gel material can be raised at least 40% by transferring sol-gel material from THF to PMAc. Therefore, a thick and uniform film can be formed more easily, since the solid content of the sol-gel material has been increased.

### Embodiment 5

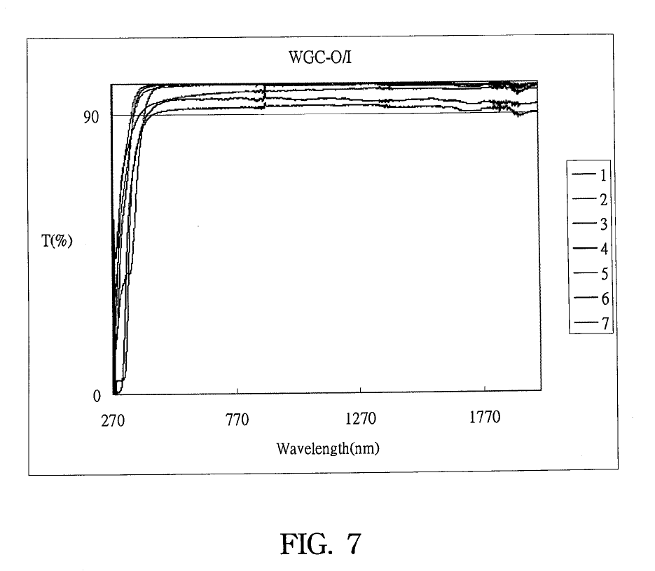

In the embodiment of the present invention, by using the functionalized sol-gel material prepared in embodiment 4, the thick sol-gel films were prepared and then the transmission of the sol-gel films were detected. All the procedures of preparing the thick sol-gel films were the same as described in embodiment 3. There are varieties of photo initiators can be used, such as CHEMCURE481, ITX907, Irgacure 184, Irgacure 907, etc. The amount of the photo initiators added is 1-5% of the solid content of MPTMS. In this embodiment, the photo initiator used was CHEMCURE481, and the amount of photo initiator added is 3% on the substrate. The transmission testing results were shown in Table 3 and FIG. 7.

TABLE 3
Transmission testing result

| | Sample No. | | | | | | | | |
|---|---|---|---|---|---|---|---|---|---|
| | 1 | 2 | 3 | 4 | 5 | 6 | 7 | 8 | 9 |
| Amount | 3% | 3% | 3% | 3% | 3% | 3% | 3% | 3% | 3% |
| of | | | | | | | | | |
| Photo | | | | | | | | | |
| initiator | | | | | | | | | |
| (%) | | | | | | | | | |
| Trans- | over | over | over | over | over | over | over | over | over |
| mission | 90 | 90 | 90 | 90 | 90 | 90 | 90 | 90 | 90 |
| (%) | | | | | | | | | |

According to the transmission results shown in Table 3 and FIG. 7, the transmission of the sol-gel film coated on a glass is over 90% in the scanning range of 270 nm to 2000 nm.

### Embodiment 6

The photo- or thermal-sensitivity of sol-gel materials is highly related-to the predetermined functional group of the organically modified Si-alkoxide. Since MPTMS is with a photosensitive functional group, the sol-gel materials prepared by MPTMS above are photosensitive. In this embodiment of the present invention, three thermal-sensitive sol-gel materials were provided by using 3-glycidoxypropyl tri-methoxysilane (GPTS) comprising a thermal sensitive functional group. Basically, the process of preparing thermal-sensitive sol-gel materials was the same as described in embodiment 1. All the reactants of the three samples were listed in the following Table 4. Instead of MPTMS, the organically modified Si-alkoxide used was GPTS. Furthermore, not only THF but also MeOH could be used as the first solvent and second solvent, and the acid added were either HCl or HNO₃.

TABLE 4
the reactants used for preparing the functionalized sol-gel material

| | | Sample | | |
|---|---|---|---|---|
| Reactants | | 10 | 11 | 12 |
| First | GPTS (g) | 3.5 g | 3.5 g | 46.5 |
| Solution | Solvent (g) | THF | MeOH | THF |
| | | 30 g | 15 g | 40 g |
| | Acid (g) | HNO₃ | HNO₃ | HCl |
| | | 8 | 8 | 8 |
| | H₂O (g) | 0.22 | 0.22 | 0 |
| Second | Metal alkoxides/ | tertabutyl | tertabutyl | tetraethyl |
| Solution | silicon | orthotitanate | orthotitanate | orthosilicate |
| | alkoxide (g) | (Ti(OC₄H₉)₄ | (Ti(OC₄H₉)₄ | Si(OC₂H₅)₄ |
| | | 30 | 30 | 46.77 |
| | Solvent (g) | THF | MeOH | THF |
| | | 30 | 15 | 40 |

| | | | |
|---|---|---|---|
| Solid Content in THF (%) | 15 | 27.5 | 25 |
| Concentrated in THF (%) | 38 | 37 | 50 |

The thermal-sensitive sol-gel materials above can be used for preparing a sol-gel material as well. First, the thermal-sensitive sol-gel can material is mixed with epoxy merchandise, such as epoxy 4221, and then amine hardener is added. Next, as shown in FIG. 4, the mixture is coated onto a substrate. After that, the substrate is baked at below 150° C. so that a sol-gel material can be derived.

According to the aforementioned embodiments of the present invention, a functionalized organic-inorganic sol-gel material is prepared without any chelating agents in selected solvents. The resultant sol-gel particles are on a nanometer scale, and are stably dispersed in the selected solvents. On the other hand, a thick sol-gel film is fabricated by means of the sol-gel material of which solid content is effectively increased by transferring the same into another solvent.

While the invention has been particularly shown and described with reference to the embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. An organic-inorganic sol-gel material, the material comprising:
at least a functionalized nanoparticle having at least a predetermined functional group and with a particle size smaller than 100 nm, wherein the functionalized nanoparticle is obtained by reacting a metal alkoxide or a silicon alkoxide with an organically modified Si-alkoxide having the predetermined functional group without adding any chelating agent, wherein the metal alkoxide or the silicon alkoxide is formulated as M(OR)x, M represents a metal atom or a silicon atom, and R is a C₁-C₁₂ alkyl.

2. The material of claim 1, further comprising a solvent for dispersing the functionalized nanoparticle, wherein the dielectric constant of the solvent is less than about 10.

3. The material of claim 2, wherein the solvent comprises tetrahydrofuran, toluene, or propylene glycol monoether acetate.

4. The material of claim 1, wherein the metal atom is selected from a group consisting of titanium (Ti), zirconium (Zr), germanium (Ge), and tin (Sn).

5. The material of claim 1, wherein the M(OR)x comprises zirconium butoxide, zirconium proxide, germanium (iv) ethoxide, germanium (iv) isopropoxide, titanium ethoxide, tertabutyl orthotitanate, tin (iv) tert-butoxide, zirconium (iv) propoxide, or tetraethyl orthosilicate.

6. The material of claim 1, wherein M represents the silicon atom.

7. The material of claim 1, wherein the silicon alkoxide comprises tetraethyl orthosilicate.

8. The material of claim 1, wherein the predetermined functional group comprises an unsaturated functional group.

9. The material of claim 8, wherein the unsaturated functional group comprises a vinyl group, an acryl group, or a photosensitive derivative thereof.

10. The material of claim 9, wherein the organically modified si-alkoxide is methacryloxypropyl tri-methoxysilane.

11. The material of claim 1, wherein the predetermined functional group comprises an epoxy group or an amine group.

12. The material of claim 11, wherein the organically modified Si-alkoxide is 3-glycidoxypropyl tri-methoxysilane.
